(19) United States
(12) Patent Application Publication
(10) Pub. No.: US 2022/0269952 A1
(43) Pub. Date: Aug. 25, 2022

(54) METHOD OF TRAINING PREDICTION MODEL, PREDICTION METHOD, ELECTRONIC DEVICE AND MEDIUM

(71) Applicant: Beijing Baidu Netcom Science Technology Co., Ltd., Beijing (CN)

(72) Inventors: Yihang CHENG, Beijing (CN); Hongke ZHAO, Beijing (CN); Hengshu ZHU, Beijing (CN); Zheng DONG, Beijing (CN); Xi ZHANG, Beijing (CN)

(21) Appl. No.: 17/739,555

(22) Filed: May 9, 2022

(30) Foreign Application Priority Data
May 13, 2021 (CN) 202110525521.9

(51) Int. Cl. G06N 5/02; G06N 3/08

(52) U.S. Cl. CPC G06N 5/02; G06N 3/08

(57) ABSTRACT

Provided are a method of training a prediction model, a prediction method, an electronic device and a medium, which relate to the field of artificial intelligence technology, and in particular, to the field of Big Data. A prediction model includes a main prediction model and an auxiliary prediction model, a training sample set includes a project information sample of a project and an item information sample of an item associated with the project, a project information sample includes a project property information and a project comment information, and an item information sample includes an item comment information. The method includes: inputting the project comment information to the auxiliary prediction model to obtain an initial prediction semantic information; training the main prediction model by using the project property information and the initial prediction semantic information; and training the auxiliary prediction model by using the item comment information.

### CROSS-REFERENCE TO RELATED APPLICATION

This application claims the benefit of Chinese Patent Application No. 202110525521.9 filed on May 13, 2021, the whole disclosure of which is incorporated herein by reference.

### TECHNICAL FIELD

The present disclosure relates to a field of artificial intelligence technology, and in particular, to a field of Big Data.

### BACKGROUND

To increase the capital vitality of financial markets, different projects may be carried out. In order to better carry out the project, attracting supporters to carry out financial activities for the project is often needed.

Supporters may, for their own benefits, determine whether to carry out financial activities for the project based on financial results of the project, where the financial results may include a success of the financial activities or a failure of the financial activities.

### SUMMARY

Provided are a method of training a prediction model, a prediction method, an electronic device and a storage medium.

According to an aspect, a method of training a prediction model by using a training sample set is provided, the prediction model includes a main prediction model and an auxiliary prediction model, the training sample set includes a project information sample of a project and an item information sample of an item associated with the project, the project information sample includes a project property information and a project comment information, and the item information sample includes an item comment information, and the method includes: inputting the project comment information to the auxiliary prediction model to obtain an initial prediction semantic information corresponding to the project comment information; training the main prediction model by using the project property information and the initial prediction semantic information corresponding to the project comment information; and training the auxiliary prediction model by using the item comment information.

According to another aspect, a prediction method is provided, including: obtaining a project property information and a project comment information of a target project; and inputting the project property information and the project comment information of the target project to a prediction model to obtain a prediction result for the target project, and the prediction model is trained by using the method described above.

According to another aspect, an electronic device is provided, including: at least one processor; and a memory communicatively connected with the at least one processor; the memory stores instructions executable by the at least one processor, and the instructions, when executed by the at least one processor, cause the at least one processor to implement the method described above.

According to another aspect, a non-transitory computer-readable storage medium having computer instructions stored thereon is provided, the computer instructions are configured to cause a computer to implement the method described above.

It should be understood that the content described in this section is not intended to identify key or critical features of embodiments of the present disclosure, nor is it intended to limit the scope of the present disclosure. Other features of the present disclosure will become readily understood from the following descriptions.

### BRIEF DESCRIPTION OF THE DRAWINGS

The accompanying drawings are used to better understand the solution, and do not constitute a limitation to the present disclosure, in which:

FIG. 1 schematically shows an exemplary system architecture of a method and an apparatus of training a prediction model by using a training sample set according to an embodiment of the present disclosure;

FIG. 2 schematically shows a flowchart of a method of training a prediction model by using a training sample set according to an embodiment of the present disclosure;

FIG. 3 schematically shows a flowchart of a method of training a prediction model by using a training sample set according to another embodiment of the present disclosure;

FIG. 4 schematically shows a schematic diagram of training a prediction model by using a training sample set according to an embodiment of the present disclosure;

FIG. 5 schematically shows a flowchart of a method of training a prediction model by using a training sample set according to another embodiment of the present disclosure;

FIG. 6 schematically shows a schematic diagram of training a prediction model by using a training sample set according to another embodiment of the present disclosure;

FIG. 7 schematically shows a flowchart of a prediction method according to an embodiment of the present disclosure;

FIG. 8 schematically shows a block diagram of an apparatus of training a prediction model by using a training sample set according to an embodiment of the present disclosure;

FIG. 9 schematically shows a block diagram of a prediction apparatus according to an embodiment of the present disclosure; and

FIG. 10 schematically shows a block diagram of an electronic device suitable for implementing the above-mentioned method according to an embodiment of the present disclosure.

### DETAILED DESCRIPTION OF EMBODIMENTS

Exemplary embodiments of the present disclosure are described below with reference to the accompanying drawings, in which various details of the embodiments of the present disclosure are included to facilitate understanding, and they should be considered as exemplary only. Accordingly, those of ordinary skill in the art should recognize that various changes and modifications may be made to the embodiments described herein without departing from the scope and spirit of the present disclosure. Also, descriptions of well-known functions and constructions are omitted from the following descriptions for clarity and conciseness.

The obtaining of a prediction model may be realized by dividing a training process of the prediction model into a plurality of operations such as feature extraction and classifier design, in which each operation is independent of each other. That is, a feature extraction model may be used first to perform feature extraction on project information to obtain feature information, and then the feature information may be used to train a classifier model to obtain a prediction model capable of being used to predict a financial result of the project. A training process of the feature extraction model and a training process of the classifier model are independent of each other, that is, in the process of training a prediction model (i.e., a classifier model) capable of being used to predict the financial result of the project, the feature extraction model may be understood as a pre-trained model. The project information may include project property information, and the project property information may include information such as a project name, a creation time, etc.

In a process of realizing a concept of the present disclosure, it is found that there is at least a problem of low prediction accuracy in the above-mentioned method. With an in-depth research, it is further found that this is mainly caused by the following two reasons.

First, it is difficult to determine a global optimal solution. The above-mentioned manner of training the prediction model may be understood as a manner of transforming solving a problem into solving a plurality of independent sub-problems. For each sub-problem, an optimal solution thereof may be found to the greatest extent, and the optimal solution of each sub-problem may be understood as a local optimal solution. However, since solving each sub-problem is an independent process, therefore, there is a lack of unified utilization of information. Therefore, a result obtained based on each local optimal solution may not be the global optimal solution. In other words, it is difficult to determine that the result obtained based on each local optimal solution is the global optimal solution.

Second, there is a lack of mining of market prospect information contained in the project. The market prospect information may include two layers of latent semantic information, i.e., a market prospect and a semantic opinion. The market prospect characterizes whether a discussion content of the project is concerned by the users, and the semantic opinion characterizes an opinion of a potential supporter. In addition to the project property information of the project, the market prospect information of the project is also an important factor needed to be considered by the supporter when making a support decision. Therefore, a construction of a prediction model with high forecast accuracy needs to rely on the project market prospect information. In addition, since the mining of the market prospect information of the project needs to rely on project comment information with tag information, but the project comment information with the tag information is actually lacking, so it is difficult to mine the market prospect information of the project. The tag information in the project comment information with tag information may refer to an evaluation result characterized by the project comment information. The evaluation result may be reflected in a form of evaluation scores.

In order to solve the problem of the low prediction accuracy of the prediction model, it is found that the market prospect information contained in the project needs to be mined as much as possible so as to realize a determination of the global optimal solution. In order to mine the market prospect information contained in the project as much as possible, it is needed to obtain the project comment information with tag information as much as possible. It is found that although it is actually difficult to directly obtain project comment information with tag information, it is possible to indirectly make the project comment information with the tag information. That is, since item comment information of an item associated with the project and tag information corresponding to the item comment information may be obtained, i.e., the item comment information with tag information may be obtained, and the project comment information of the project is similar to the item comment information of the item associated with the project, therefore, the market prospect information contained in the project comment information may be mined by using the item comment information with tag information by means of transfer learning.

In addition, in order to determine the global optimal solution, an end-to-end training may be used. That is, a deep network model is used to directly learn a mapping relationship between a training sample set input from an input end and a prediction result obtained from an output end, and in a training process of the deep network model, an output value of a loss function is used to adjust a model parameter of each layer in the deep network model.

Since the purpose of the prediction model is to realize the financial result of the prediction project, and the item comment information with tag information is needed to mine the market prospect information contained in the project, the prediction model may be divided into a main prediction model and an auxiliary prediction model. The main prediction model may be used to predict the financial result of the project, and the auxiliary prediction model may be used to mine the market prospect information contained in the project. In addition, the result obtained by using the auxiliary prediction model may also participate in the training process of the main prediction model. Since the end-to-end training method is adopted, the main prediction model and the auxiliary prediction model are jointly trained rather than independently trained. In other words, the training process of the prediction model is the joint training process of the main prediction model and the auxiliary prediction model.

Based on the above, the embodiments of the present disclosure propose a solution combining the transfer learning with a multi-task learning to solve the problem of low prediction accuracy of the prediction model. Specifically, the embodiments of the present disclosure provide a method and an apparatus of training a prediction model by using a training sample set, a prediction method, a prediction apparatus, an electronic device, and a storage medium. The prediction model includes a main prediction model and an auxiliary prediction model, the training sample set includes a project information sample of a project and an item information sample of an item associated with the project, the project information sample includes a project property information and a project comment information, and the item information sample includes an item comment information. The method of training the prediction model by using the training sample set includes: inputting the project comment information to the auxiliary prediction model to obtain an initial prediction semantic information corresponding to the project comment information, training the main prediction model by using the project property information and the initial prediction semantic information corresponding to the project comment information, and training the auxiliary prediction model by using the item comment information.

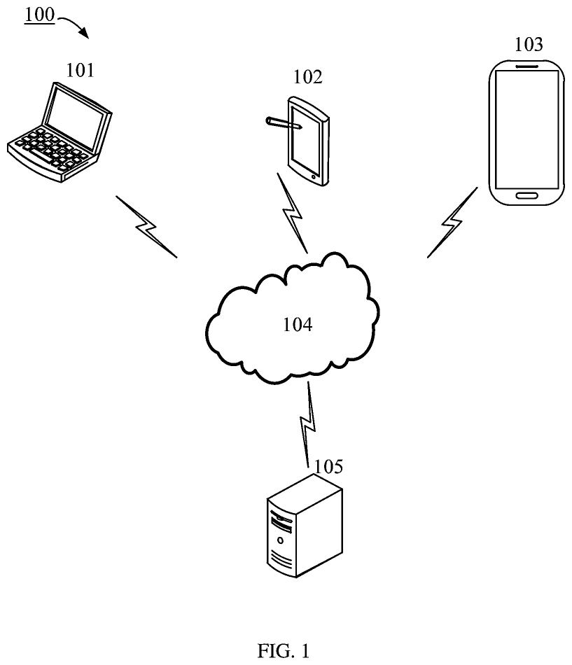

FIG. 1 schematically shows an exemplary system architecture of a method and an apparatus of training a prediction model by using a training sample set according to an embodiment of the present disclosure.

It should be noted that FIG. 1 is only an example to which a system architecture of the embodiment of the present disclosure may be applied, so as to facilitate those skilled in the art to understand a technical content of the present disclosure. However, it does not mean that the embodiments of the present disclosure may not be used in other devices, systems, environments or scenarios. For example, in another embodiment, an exemplary system architecture capable of being used for a method and an apparatus of training a prediction model may include a terminal device, and the terminal device may implement the method and the apparatus of training the prediction model by using the training sample set provided by the embodiment of the present disclosure, without interacting with a server.

As shown in FIG. 1, the system architecture 100 according to the embodiment may include terminal devices 101, 102, and 103, a network 104 and a server 105. The network 104 is a medium used to provide a communication link between the terminal devices 101, 102, 103 and the server 105. The network 104 may include various connection types, such as wired and/or wireless communication links, and the like.

The user may use the terminal devices 101, 102, 103 to interact with the server 105 through the network 104 to receive or transmit messages and the like. Various communication client applications such as knowledge reading applications, web browser applications, search applications, instant messaging tools, email clients and/or social platform software, etc. (only exemplarily) may be installed on the terminal devices 101, 102 and 103.

The terminal devices 101, 102, and 103 may be various electronic devices having a display screen and supporting web browsing, including but not limited to smart phones, tablet computers, laptop computers, desktop computers, etc.

The server 105 may be a server that provides various services. For example, the server may be used to input the project comment information to the auxiliary prediction model to obtain initial prediction semantic information corresponding to the project comment information, and may be used to train the main prediction model by using the project property information and the initial prediction semantic information corresponding to the project comment information, and may be used to train the auxiliary prediction model by using the item comment information.

It should be noted that, the method of training the prediction model by using the training sample set provided by the embodiment of the present disclosure may generally be executed by the terminal devices 101, 102, or 103. Correspondingly, the apparatus of training the prediction model by using the training sample set provided by the embodiment of the present disclosure may also be provided in the terminal devices 101, 102, or 103.

Alternatively, the method of training the prediction model by using the training sample set provided by the embodiment of the present disclosure may generally be executed by the server 105. Correspondingly, the apparatus of training the prediction model by using the training sample set provided by the embodiment of the present disclosure may generally be provided in the server 105. The method of training the prediction model using the training sample set provided by the embodiment of the present disclosure may also be executed by a server or a server cluster different from the server 105 and communicated with the terminal devices 101, 102, 103 and/or the server 105. Correspondingly, the apparatus of training the prediction model by using the training sample set provided by the embodiment of the present disclosure may also be provided in a server or a server cluster different from the server 105 and communicated with the terminal devices 101, 102, 103 and/or the server 105.

It should be understood that numbers of the terminal devices, the network and the server in FIG. 1 are merely illustrative. There may be any number of terminal devices, networks and servers according to implementation requirements.

According to the embodiment of the present disclosure, a method of training a prediction model by using a training sample set is provided. The prediction model may include a main prediction model and an auxiliary prediction model, the training sample set may include a project information sample of a project and an item information sample of an item associated with the project, the project information sample may include a project property information and a project comment information, and the item information sample may include an item comment information.

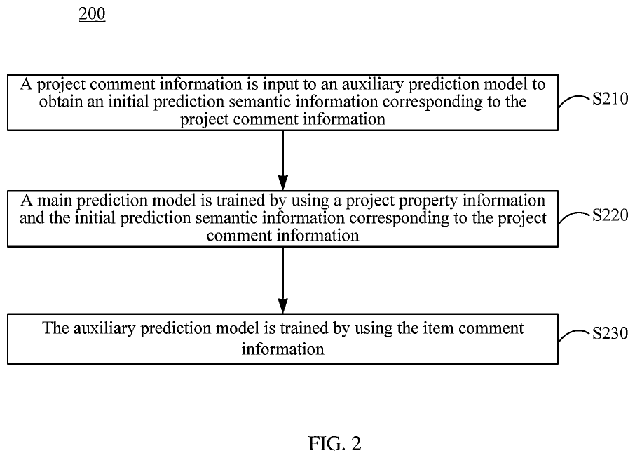

FIG. 2 schematically shows a flowchart of a method 200 of training a prediction model by using a training sample set according to an embodiment of the present disclosure.

As shown in FIG. 2, the method includes operations S210-S230.

In operation S210, the project comment information is input to the auxiliary prediction model to obtain an initial prediction semantic information corresponding to the project comment information.

In operation S220, the main prediction model is trained by using the project property information and the initial prediction semantic information corresponding to the project comment information.

In operation S230, the auxiliary prediction model is trained by using the item comment information.

According to the embodiment of the present disclosure, a training sample set may be obtained. The training sample set may include a project information sample of a project and an item information sample of an item associated with the project. The training sample set may include one or more project information samples. The training sample set may include one or more item information samples. There may be one or more projects. The project property information may include information such as a project name and a creation time. The item associated with the project may be understood as an item of the same or similar project type as the project. For example, the project may be a project related to an electronic device, then the item associated with the project may be understood to be an electronic device. It should be noted that, in the technical solution of the embodiment of the present disclosure, the collection, storage, use, processing, transmission, provision, disclosure, application, etc. of the project information samples and item information samples involved are in compliance with the provisions of relevant laws and regulations, necessary confidentiality measures have been taken, which does not violate the public order and good customs.

According to the embodiment of the present disclosure, after the training sample set is obtained, the prediction model including the main prediction model and the auxiliary prediction model may be trained by using the training sample set, which may include following operations. In case that the project information sample is obtained from the training sample set, the auxiliary prediction model is trained by using the project comment information, and the main prediction model is trained by using the project property information and the result obtained by using the project comment information to train the auxiliary prediction model. That is, the project comment information is input to the auxiliary prediction model to obtain the initial prediction semantic information corresponding to the project comment information, and the main prediction model is trained by using the project property information and the initial prediction semantic information corresponding to the project comment information. In case that the item information sample is obtained from the training sample set, the auxiliary prediction model is trained by using the item comment information. That is, for the project information sample in the training sample set, the main prediction model and the auxiliary prediction model may be trained by using the project information sample. For the item information sample in the training sample set, the auxiliary prediction model may be trained by using the item comment information.

According to the embodiment of the present disclosure, model structures of the main prediction model and the auxiliary prediction model may be set according to actual conditions, which are not limited here. For example, the main prediction model and the auxiliary prediction model may include input layers, convolutional layers, fully connected layers, and output layers. The initial prediction semantic information corresponding to the project comment information may be understood as low-level semantic information, which may characterize semantic information expressed by the project comment information.

According to the embodiment of the present disclosure, the item comment information may be used to train the auxiliary prediction model, the project comment information may also be used to train the auxiliary prediction model, the project property information and the initial prediction semantic information corresponding to the project comment information are needed to train the main prediction model, and the initial prediction semantic information corresponding to the project comment information is obtained by inputting the project comment information to the auxiliary prediction model. Therefore, the training of the main prediction model and the training of the auxiliary prediction model may be mutually affected. During the training process of the main prediction model and the auxiliary prediction model, the model parameters of the main prediction model and the auxiliary prediction model may be adjusted according to an output value of a loss function, that is, whether the model parameters of the main prediction model and the model parameters of the auxiliary prediction model need to be adjusted are all affected by the output value of the loss function, from which it can be shown that the training of the main prediction model and the auxiliary prediction model by using the training sample set is a joint training rather than independent trainings.

It should be noted that, the operations S210 to S230 are performed alternately.

According to the embodiment of the present disclosure, the prediction model is trained by using the training sample set, that is, the project comment information is input to the auxiliary prediction model to obtain the initial prediction semantic information corresponding to the project comment information, the main prediction model is trained by using the project property information and the initial prediction semantic information corresponding to the project comment information, and the auxiliary prediction model is trained by using the item comment information, thereby realizing the joint training of the main prediction model and the auxiliary prediction model. In addition, both the item comment information and the project comment information participate in the training of the auxiliary prediction model, so that the item comment information may be used to mine the market prospect information contained in the project comment information, thereby a prediction accuracy of the prediction model is increased. Therefore, the technical problem of low prediction accuracy of the prediction model is at least partially overcome.

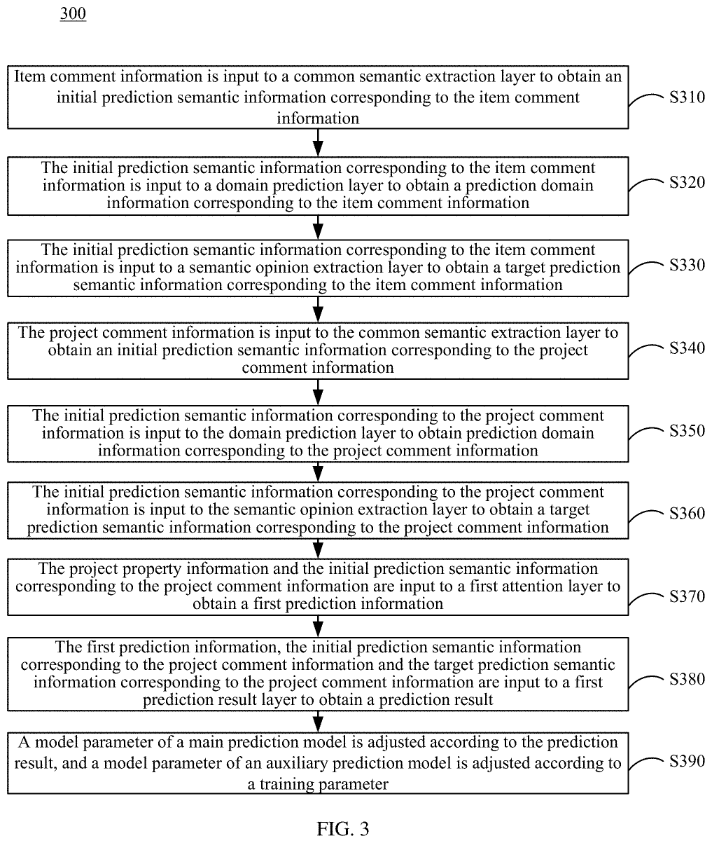

The method shown in FIG. 2 will be further described below with reference to FIG. 3 to FIG. 6 in conjunction with specific embodiment.

FIG. 3 schematically shows a flowchart of a method 300 of training a prediction model by using a training sample set according to another embodiment of the present disclosure.

As shown in FIG. 3, the method includes operations S310-S390.

In operation S310, the item comment information is input to a common semantic extraction layer to obtain an initial prediction semantic information corresponding to the item comment information.

In operation S320, the initial prediction semantic information corresponding to the item comment information is input to a domain prediction layer to obtain a prediction domain information corresponding to the item comment information.

In operation S330, the initial prediction semantic information corresponding to the item comment information is input to a semantic opinion extraction layer to obtain a target prediction semantic information corresponding to the item comment information.

In operation S340, the project comment information is input to the common semantic extraction layer to obtain an initial prediction semantic information corresponding to the project comment information.

In operation S350, the initial prediction semantic information corresponding to the project comment information is input to the domain prediction layer to obtain prediction domain information corresponding to the project comment information.

In operation S360, the initial prediction semantic information corresponding to the project comment information is input to the semantic opinion extraction layer to obtain a target prediction semantic information corresponding to the project comment information.

In operation S370, the project property information and the initial prediction semantic information corresponding to the project comment information are input to a first attention layer to obtain a first prediction information.

In operation S380, the first prediction information, the initial prediction semantic information corresponding to the project comment information and the target prediction semantic information corresponding to the project comment information are input to a first prediction result layer to obtain a prediction result, and the prediction result is used to characterize a financial result of the project.

In operation S390, a model parameter of a main prediction model is adjusted according to the prediction result, and a model parameter of an auxiliary prediction model is adjusted according to a training parameter. The training parameter includes the prediction domain information and the target prediction semantic information corresponding to the item comment information.

According to the embodiment of the present disclosure, the auxiliary prediction model may include a common semantic extraction layer. The common semantic extraction layer may be used to extract the initial prediction semantic information. A network structure of the common semantic extraction layer may be set according to the actual situations, which is not limited here.

According to the embodiment of the present disclosure, the auxiliary prediction model may include a semantic opinion extraction layer in addition to the common semantic extraction layer. The semantic opinion extraction layer may be used to extract target prediction semantic information. The target prediction semantic information may be understood as high-level semantic information, which may characterize opinion information expressed by the comment information.

According to the embodiment of the present disclosure, the auxiliary prediction model may further include a domain prediction layer, and the domain prediction layer may be used to determine a domain to which the comment information belongs. The comment information may include the project comment information or the item comment information. The domain may include a project domain or an item domain.

According to the embodiment of the present disclosure, the purpose of training the auxiliary prediction model is to use the item comment information with tag information to mine the market prospect information contained in the project comment information, that is, to make it possible to use the tag information corresponding to the item comment information to characterize the market prospect information contained in the project comment information. Therefore, it is needed to make it difficult for the trained auxiliary prediction model to distinguish the project comment information from the item comment information. This may be achieved by training the domain prediction layer, the common semantic extraction layer and the semantic opinion extraction layer included in the auxiliary prediction model. After the comment information is input to the auxiliary prediction model, the common semantic extraction layer is used first to extract the initial prediction semantic information of the comment information, and then the domain prediction layer is used to determine the domain to which the comment information belongs, and the semantic opinion extraction layer is used to extract the target prediction semantic information of the comment information.

According to the embodiment of the present disclosure, both the project comment information and the item comment information will pass through the above-mentioned common semantic extraction layer, domain prediction layer, and semantic opinion extraction layer. Therefore, with the progress of training, the common semantic extraction layer may continuously learn common semantic information expressed by both the project comment information and the item comment information. In addition, the domain prediction layer may continuously learn in a direction that it is difficult to distinguish the domain to which the project comment information belongs from the domain to which the item comment information belongs. The difficult to distinguish the domain to which the project comment information belongs from the domain to which the item comment information belongs may be understood as determining the domain to which the project comment information belongs as the item domain rather than the project domain.

On this basis, if it is difficult for the domain prediction layer to distinguish the domain to which the project comment information belongs from the domain to which the item comment information belongs, it can be shown that the tag information corresponding to the item comment information may be used to characterize the market prospect information contained in the project comment information. Therefore, the target prediction semantic information corresponding to the project comment information extracted by the semantic opinion extraction layer is the market prospect information contained in the project comment information.

In the process of training the auxiliary prediction model, the common semantic extraction layer, the domain prediction layer and the semantic opinion extraction layer included in the auxiliary prediction model are mutually affected, that is, the initial prediction semantic information input from the common semantic extraction layer will be input to the domain prediction layer and semantic opinion extraction layer.

According to the embodiment of the present disclosure, the operation S210 may be implemented by the operation S340, the operation S220 may be implemented by the operation S360, in which the project property information, the initial prediction semantic information corresponding to the project comment information and the target prediction semantic information corresponding to the project comment information are input to the main prediction model to obtain the prediction result, and the model parameter of the main prediction model is adjusted according to the prediction result. The operation S230 may be implemented through operations S310 to S330, in which the model parameter of the auxiliary prediction model is adjusted according to the training parameter.

According to the embodiment of the present disclosure, the main prediction model and the auxiliary prediction model may be jointly trained by using the training sample set. For example, in case that the item information sample is obtained from the training sample set, the item comment information is input to the common semantic extraction layer to obtain the initial prediction semantic information corresponding to the item comment information. The initial prediction semantic information corresponding to the item comment information is input to the domain prediction layer to obtain the prediction domain information corresponding to the item comment information. The initial prediction semantic information corresponding to the item comment information is input to the semantic opinion extraction layer to obtain the target prediction semantic information corresponding to the item comment information. In case that the project information sample is obtained from the training sample set, the project comment information is input to the common semantic extraction layer to obtain the initial prediction semantic information corresponding to the project comment information. The initial prediction semantic information corresponding to the project comment information is input to the domain prediction layer to obtain the prediction domain information corresponding to the project comment information. The initial prediction semantic information corresponding to the project comment information is input to the semantic opinion extraction layer to obtain the target prediction semantic information corresponding to the project comment information. The project property information, the initial prediction semantic information corresponding to the project comment information and the target prediction semantic information corresponding to the project comment information are input to the main prediction model to obtain the prediction result. The prediction result may include a result of a project success or a project failure.

According to the embodiment of the present disclosure, the model parameters of the auxiliary prediction model and the main prediction model may be adjusted according to the training information to obtain the trained auxiliary prediction model and the trained main prediction model. The training information may include the prediction result, the prediction domain information corresponding to the project comment information, the initial prediction semantic information corresponding to project comment information, the target prediction semantic information corresponding to the project comment information, the prediction domain information corresponding to the item comment information, and the target prediction semantic information corresponding to the item comment information. The trained auxiliary prediction model and the trained main prediction model are determined as the prediction model.

According to the embodiment of the present disclosure, an attention mechanism may be used to narrow a transfer gap between the project domain and the item domain, and to improve a training efficiency of the model, that is, an attention layer is provided in the main prediction model. This is because the attention mechanism may focus on important information with high weight, ignore unimportant information with low weight, and may exchange information with other information by sharing the important information, thereby realizing a transmission of the important information. In this way, a higher weight may be set for the important information to achieve the transmission of the important information, thereby narrowing the transfer gap between the project domain and the item domain.

According to the embodiment of the present disclosure, an implementation of the attention mechanism may be: the main prediction model includes a first attention layer and a first prediction result layer. The first attention layer may be an attention layer processing the project property information and the initial prediction semantic information corresponding to the project comment information. The first attention layer may be used to extract the common semantic information of the project property information and the item comment information. The reason why the first attention layer may be used to extract the common semantic information of the project property information and the item comment information is the common semantic extraction layer may be used to extract the common semantic information of the project comment information and the item comment information, the initial prediction semantic information corresponding to the project comment information is obtained by inputting the project comment information to the common semantic extraction layer. Therefore, the initial prediction semantic information corresponding to the project comment information may reflect the common semantic information with the item comment information. Therefore, the first attention layer may be used to extract the common semantic information of the project property information and the item comment information.

According to the embodiment of the present disclosure, the main prediction model may include the first attention layer and the first prediction result layer. Inputting the project property information, the initial prediction semantic information corresponding to the project comment information and the target prediction semantic information corresponding to the project comment information to the main prediction model to obtain the prediction result may include the operations S370-S380.

For example, the first prediction information may be characterized by the following formula (1).

$${h}^{{f}^{i}} = {\sum }_{q = 1}^{{n}^{{f}^{i}}} {a}_{q} \cdot {h}_{att}^{{f}^{i}} \qquad ( 1 )$$

In which, f characterizes the project property information, fⁱ=n^{f}^{ᵢ}·hₐₜₜ^{f}^{ⁱ}, n^{f}^{ⁱ} characterizes the number, lᵢ characterizes a length of hₐₜₜ^{f}^{ⁱ}, lᵢ=s₀·a_{q}=Softmax(V^{T}·tanh(Wₐₜₜ·(s₀ ⊕hₐₜₜ^{f}^{ⁱ}))), Wₐₜₜ and V^{T} characterize the model parameters.

According to the embodiment of the present disclosure, the transfer gap between the project domain and the item domain is narrowed through the attention mechanism, thereby improving the training efficiency of the model. In addition, a consistency of the project domain and the item domain may also be ensured as much as possible, that is, the information input to the first prediction result layer and the second prediction result layer may be related to the project property information as much as possible.

According to the embodiment of the present disclosure, the project information sample may further include a first real domain information and a real result, and the item comment information sample may further include a real semantic information and a second real domain information. The above method of training the prediction model by using the training sample set may further include the following operations.

A first output value is obtained by using the target prediction semantic information corresponding to the item comment information and the real semantic information corresponding to the item comment information based on the first loss function. A second output value is obtained by using the prediction domain information corresponding to the project comment information and the first real field information corresponding to the project comment information based on a second loss function. The prediction domain information corresponding to the project comment information is obtained by inputting the project comment information to the domain prediction layer. A third output value is obtained by using the prediction domain information corresponding to the item comment information and the second real domain information corresponding to the item comment information based on the second loss function based on the second loss function. A fourth output value is obtained by using the prediction result corresponding to the project comment information and the real result corresponding to the project comment information based on a third loss function. According to the first output value, the second output value, the third output value and the fourth output value, the model parameters of the main prediction model and the auxiliary prediction model are adjusted until the first output value, the second output value, the third output value and the third output value are all converged.

According to the embodiment of the present disclosure, three loss functions, namely the first loss function, the second loss function and the third loss function are designed to effectively train the prediction model. The first loss function and the second loss function may be used to train the auxiliary prediction model, and the third loss function may be used to train the main prediction model.

According to the embodiment of the present disclosure, the real semantic information corresponding to the item comment information may be understood as the tag information corresponding to the item comment information. For the first loss function, the target prediction semantic information corresponding to the item comment information and the real semantic information corresponding to the item comment information may be input to the first loss function to obtain the first output value. For the second loss function, the prediction domain information corresponding to the project comment information and the first real domain information corresponding to the project comment information may be input to the second loss function to obtain the second output value; the prediction domain information corresponding to the item comment information and the second real domain information corresponding to the item comment information is input to the second loss function to obtain the third output value. For the third loss function, the prediction result corresponding to the project comment information and the real result corresponding to the project comment information may be input to the third loss function to obtain the fourth output value.

According to the embodiment of the present disclosure, after obtaining the first output value, the second output value, the third output value and the fourth output value, the model parameters of the main prediction model and the auxiliary prediction model may be adjusted according to the above output values, and the above-mentioned operations of determining the output values may be repeated until the above-mentioned output values are all converged. The main prediction model and the auxiliary prediction model obtained in case that the first output value, the second output value, the third output value and the fourth output value are all converged are determined as the trained main prediction model and the trained auxiliary prediction model.

For example, the project property information is characterized by fⁱ, the project comment information is characterized by Tcⁱ, and the item comment information is characterized by Trⁱ.

The initial prediction semantic information corresponding to the project comment information Tcⁱ is characterized by Te_{c}ⁱ, the target prediction semantic information corresponding to the project comment information Tc′ is characterized by Yₛⁱ(\hat{T}o_{c}ⁱ), the prediction domain information corresponding to the project comment information Tcⁱ is characterized by Y_{d}ⁱ(\hat{T}dᵣⁱ), the first real domain information corresponding to the project comment information Tcⁱ is characterized by Y_{d}ⁱ(Td_{c}ⁱ), the prediction result corresponding to the project comment information Tcⁱ is characterized by Ŷₚⁱ, and the real result corresponding to the project comment information Tcⁱ is characterized by Yₚⁱ.

The initial prediction semantic information corresponding to the item comment information Trⁱ is characterized by Teᵣⁱ, the target prediction semantic information corresponding to the item comment information Trⁱ is characterized by Yₛⁱ(\hat{T}oᵣⁱ), the real semantic information corresponding to the item comment information Trⁱ is characterized by Yₛⁱ(Toᵣⁱ), the prediction domain information corresponding to the item comment information Trⁱ is characterized by Y_{d}ⁱ(\hat{T}dᵣⁱ), and the second real domain information corresponding to the item comment information Trⁱ is characterized by Y_{d}ⁱ(Tdᵣⁱ).

The first loss function may be characterized by the following formula (2).

$${L}_{s} ( {Θ}_{s} ) = - {\sum }_{i = 1}^{{N}_{s}} {Y}_{s}^{i} log ( {\hat{Y}}_{s}^{i} ) \qquad ( 2 )$$

Ŷₛⁱ is used to characterize the target prediction semantic information, and Ŷₛⁱ may be characterized by the following formula (3).

Ŷₛⁱ=Sigmoid(W₁′·LeakyReLU(W₁Toⁱ+b₁)+b₁′) (3)

Toⁱ may be To_{c}ⁱ or Toᵣⁱ, W₁, W₁′, b₁ and b₁′ may be used to characterize the model parameters. Nₛ is used to characterize the number of the item information samples in the training sample set.

The second loss function may be characterized by the following formula (4).

$${L}_{d} ( {Θ}_{d} , {Θ}_{d}^{′} ) = - {\sum }_{i = 1}^{{N}_{d}} {Y}_{d}^{i} log ( {\hat{Y}}_{d}^{i} ) \qquad ( 4 )$$

Ŷ_{d}ⁱ is used to characterize the prediction domain information, and Ŷ_{d}ⁱ may be characterized by the following formula (5).

Ŷ_{d}ⁱ=Sigmoid(W₂′·LeakyReLU(W₂FCN(Teⁱ)+b₂)+b₂′) (5)

Teⁱ may be Te_{c}ⁱ or Teᵣⁱ. FCN characterizes a fully-connected internet layer. W₂, W₂′, b₂ and b₂′ may be used to characterize the model parameters. Θ_{d} is used to characterize the model parameter of the common semantic extraction layer. Θ_{d}′ is used to characterize the model parameter of the domain prediction layer. N_{d} is used to characterize the number of the project information samples and the item information samples in the training sample set.

The third loss function may be characterized by the following formula (6).

$${L}_{p} ( {Θ}_{p} ) = - {\sum }_{i = 1}^{{N}_{p}} {Y}_{p}^{i} log ( {\hat{Y}}_{p}^{i} ) \qquad ( 6 )$$

Ŷₚⁱ is used to characterize the prediction result, and Ŷₚⁱ may be characterized by the following formula (7).

Ŷₚⁱ=Sigmoid(W₃′·LeakyReLU(W₃[FCN(fⁱ)⊕h^{f}^{ⁱ}⊕Tⁱ]+b₃)+b₃′) (7)

Tⁱ may be Teⁱ or Toⁱ. FCN characterizes a fully-connected internet layer. W₃, W₃′, b₃ and b₃′ may be used to characterize the model parameters. Nₚ is used to characterize the numbers of the project information samples in the training sample set.

The first output value is obtained by inputting Yₛⁱ(Toᵣⁱ) and Yₛⁱ(\hat{T}oᵣⁱ) to the formula (2). The second output value is obtained by inputting Y_{d}ⁱ(Td_{c}ⁱ) and Y_{d}ⁱ(\hat{T}dᵣⁱ) to the formula (4). The third output value is obtained by inputting Y_{d}ⁱ(Tdᵣⁱ) and Y_{d}ⁱ(\hat{T}dᵣⁱ) to the formula (4). The fourth output value is obtained by inputting Yₚⁱ and Ŷₚⁱ to the formula (6). The model parameters of the main prediction model and the auxiliary prediction model are adjusted according to the above four output values.

According to the embodiment of the present disclosure, adjusting the model parameters of the main prediction model and the auxiliary prediction model may include the following operations.

A gradient vector is obtained by using a gradient descent algorithm to process the first loss function, the second loss function and the third loss function. A component in the gradient vector associated with the second loss function is characterized by a negative partial derivative. The model parameters of the main prediction model and the auxiliary prediction model are adjusted according to the gradient vector.

According to the embodiment of the present disclosure, the gradient descent algorithm may be used to process the loss function. The gradient descent algorithm may include a stochastic gradient descent algorithm. In a process of adjusting the model parameters of the main prediction model and the auxiliary prediction model according to the gradient vector, the model parameters of the main prediction model and the auxiliary prediction model may be adjusted by using a back propagation method based on the gradient vector.

According to the embodiment of the present disclosure, the purpose of training the domain prediction layer is to make it difficult for the domain prediction layer to distinguish the domain to which the project comment information belongs from the domain to which the item comment information belongs, that is, the domain to which the project comment information belongs needs to be determined as the item domain rather than the project domain. Therefore, the component in the gradient vector associated with the second loss function may be characterized by the negative partial derivative, i.e., a negative feedback form is used in the process of training the domain prediction layer. Except for the component related to the second loss function in the gradient vector is represented by the negative partial derivative, other components may be characterized by positive partial derivatives, i.e., a positive feedback form is used in the process of training the main prediction model, the common semantic extraction layer and the semantic opinion extraction layer.

For example, the gradient descent algorithm is used to process the above formulas (2), (4) and (6) to obtain a gradient vector, which may be characterized by the following formula (8).

$$[ \frac{\partial {L}_{s}}{\partial {Θ}_{s}} , - λ \frac{\partial {L}_{d}}{\partial {Θ}_{d}} , \frac{\partial {L}_{d}}{\partial {Θ}_{d}^{′}} , \frac{\partial {L}_{p}}{\partial {Θ}_{p}} ] \qquad ( 8 )$$

$$- λ \frac{\partial {L}_{d}}{\partial {Θ}_{d}}$$

is used to characterize the negative partial derivative, λ and is used to characterize an inverting weight.

According to the embodiment of the present disclosure, the above-mentioned method of training the prediction model may further include the following operations.

An initial training sample set is obtained. A project property information included in the initial training sample set is encoded to obtain the project property information included in the training sample set. A project comment information and an item comment information included in the initial training sample set are respectively processed by using a convolutional neural network model to obtain project comment information and the item comment information included in the training sample set.

According to the embodiment of the present disclosure, the initial training sample set may include the project information sample of the project and the item information sample of the item associated with the project. The project information sample may include the project property information and the project comment information, and the item information sample may include the item comment information. A relationship between the initial training sample set and the training sample set is that the training sample set may be obtained by vector characterization for the initial training sample set.

According to the embodiment of the present disclosure, for the project property information included in the initial training sample set, since the project property information included in the initial training sample set is already characterized, it is not needed to perform feature extraction on the project property information included in the initial training sample set, it is only needed to encode the project property information included in the initial training sample set to obtain the project property information included in the training sample set. Furthermore, in addition to encoding the project property information included in the initial training sample set, normalization may also be performed on this basis. The encoding may include a one-hot encoding.

For the project comment information and the item comment information included in the initial training sample set, the convolutional neural network model may be used to process the project comment information and the item comment information included in the initial training sample set, respectively, to obtain project comment information and item comment information included in the training sample set. The convolutional neural network model may include a convolutional layer and a pooling layer. The convolutional neural network model may include one or more convolutional layers. The convolutional neural network model may include one or more pooling layers, and the pooling layer may include a max pooling layer or an average pooling layer. There may be a plurality of project comment information for the project, and there may be a plurality of item comment information for the item, thus the project comment information may be understood as being obtained by splicing the plurality of project comment information, and the item comment information may be understood as being obtained by splicing the plurality of item comment information.

According to the embodiment of the present disclosure, before processing the project comment information and the item comment information included in the initial training sample set by using the convolutional neural network model, the project comment information and the item comment information included in the initial training sample set may also be processed by using a word vector tool. The word vector tool may include Word2vec.

According to the embodiment of the present disclosure, processing the project comment information and the item comment information included in the initial training sample set respectively by using the convolutional neural network model to obtain the project comment information and the item comment information included in the training sample set may include the following operations.

A first convolutional neural network model is used to process the project comment information included in the initial training sample set to obtain the project comment information included in the training sample set. A second convolutional neural network model is used to process the item comment information included in the initial training sample set to obtain the item comment information included in the training sample set.

According to the embodiment of the present disclosure, the first convolutional neural network model may include a first convolutional layer and a first pooling layer. The project comment information included in the initial training sample set may be processed by the first convolution layer to obtain a first convolution sequence, and the first convolution sequence may be processed by using the first pooling layer to obtain the project comment information included in the training sample set. The first convolutional neural network model may include one or more first convolutional layers and one or more first pooling layers.

According to the embodiment of the present disclosure, the second convolutional neural network model may include a second convolutional layer and a second pooling layer. The item comment information included in the initial training sample set may be processed by the second convolution layer to obtain a second convolution sequence, and the second convolution sequence may be processed by using the second pooling layer to obtain the item comment information included in the training sample set. The second convolutional neural network model may include one or more second convolutional layers and one or more second pooling layers.

In order to better understand the operations of obtaining the project comment information and the item comment information included in the training sample set, in the following, referring to specific examples, the first convolutional neural network model processing the project comment information included in the initial training sample set to obtain the project comment information included in the training sample set will be described.

For example, the initial training sample set may include N projects, N≥1. eᵢ is used to characterize an iₜₕ project, i∈{1, 2, . . . , N−1, N}. The project comment information of eᵢ may be characterized by cⁱ.

The first convolutional layer may be used to process cⁱ to obtain the first convolution sequence h^{c}^{ᵢ}=\vec{h}₁^{c}^{ᵢ}, \vec{h}₂^{c}^{ᵢ}, . . . , \vec{h}ⱼ^{c}^{ᵢ}, . . . , \vec{h}ₗ_{_{c}}₋ₖ^{c}^{ᵢ}, \vec{h}ₗ_{_{c}}₋ₖ₊₁^{c}^{ᵢ}, that is, each consecutive k word vectors has a local semantic representation. \vec{h}ⱼ^{c}^{ᵢ}=σ(G[ωⱼ⊕ . . . ⊕ωⱼ₊ₖ₋₁]+b), cⁱ={ω₁, ω₂, . . . , ωⱼ, . . . , ωₗ_{_{c}}₋₁, ωₗ_{_{c}}}, G∈R^{d×kd}^{₀}, b is used to characterize a convolution parameter, b∈R^{d}, d is used to characterize the number of kernels, ⊕ is used to characterize an operation of concatenating k dimensional word vectors into a long vector, σ(x) is used to characterize a nonlinear activation function, i.e., σ(x)=LeakyReLU(x)=max(0, x)+negative_shop×min(0, x), negative_shop is used to characterize a non-zero constant. l_{c} is used to characterize the number of words included in cⁱ, ωⱼ is used to characterize the jₜₕ word embedding in cⁱ, d₀ is used to characterize a dimensionality of each word, and k×d₀ is used to characterize the number of kernels.

The first pooling layer is used to process h^{c}^{ᵢ} to obtain the project comment information Tcⁱ of eᵢ included in the training sample set, that is, the first pooling layer is used to combine the features of h^{c}^{ᵢ} into a new global hidden sequence h^{cp}^{ᵢ}={\vec{h}₁^{cp}^{ᵢ}, \vec{h}₂^{cp}^{ᵢ}, . . . , \vec{h}ₘ^{cp}^{ᵢ}, . . . , \vec{h}_{[(l}_{_{c}}_{+k-2)/p]}^{cp}^{ᵢ}, \vec{h}_{[(l}_{_{c}}_{+k-1)/p]}^{cp}^{ᵢ}}, in which,

$${\vec{h}}_{m}^{{cp}_{i}} = [ max [ \begin{matrix}{h}_{p m ‐ p + 1 , 1}^{c {p}_{i}} \\ … \\ {h}_{p m , 1}^{c {p}_{i}}\end{matrix} ] , … , max [ \begin{matrix}{h}_{p m ‐ p + 1 , d}^{c {p}_{i}} \\ … \\ {h}_{pm , d}^{c {p}_{i}}\end{matrix} ] ] ,$$

p is used to characterize a size of a filter of the first pooling layer. The above h^{cp}^{ᵢ} is the project comment information Tcⁱ of eᵢ included in the training sample set.

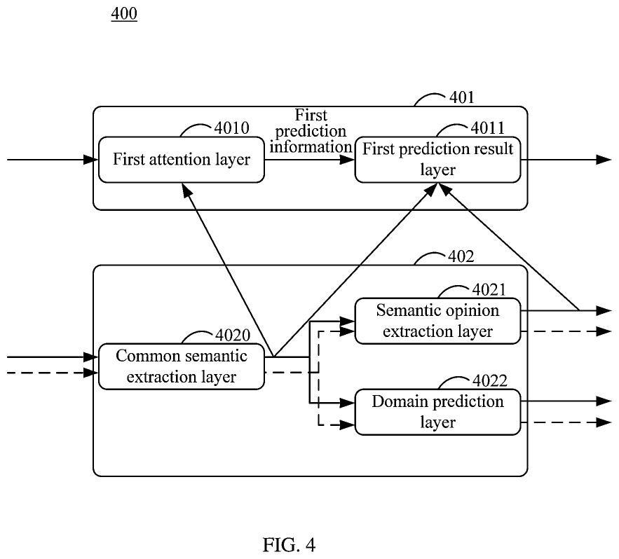

FIG. 4 schematically shows a schematic diagram of training a prediction model 400 by using a training sample set according to an embodiment of the present disclosure.

As shown in FIG. 4, a main prediction model 401 may include a first attention layer 4010 and a first prediction result layer 4011, an auxiliary prediction model 402 may include a common semantic extraction layer 4020, a semantic opinion extraction layer 4021 and a domain prediction layer 4022.

Project property information is characterized by fⁱ, project comment information is characterized by Tcⁱ, item comment information is characterized by Trⁱ. Initial prediction semantic information corresponding to the project comment information Tcⁱ is characterized by Te_{c}ⁱ, target prediction semantic information corresponding to the project comment information Tcⁱ is characterized by Yₛⁱ(\hat{T}o_{c}ⁱ), prediction domain information corresponding to the project comment information Tcⁱ is characterized by Y_{d}ⁱ(\hat{T}dᵣⁱ), and a prediction result corresponding to the project comment information Tcⁱ is characterized by Ŷₚⁱ.

Tcⁱ is processed by using the common semantic extraction layer 4020 to obtain Te_{c}ⁱ. Te_{c}ⁱ is processed by using the semantic opinion extraction layer 4021 to obtain Yₛⁱ(\hat{T}o_{c}ⁱ). Te_{c}ⁱ is processed by using the domain prediction layer 4022 to obtain Y_{d}ⁱ(\hat{T}dᵣⁱ). fⁱ and Te_{c}ⁱ are processed by using the first attention layer 4010 to obtain first prediction information. The first prediction information, Te_{c}ⁱ and Yₛⁱ(\hat{T}o_{c}ⁱ) are processed by using the first prediction result layer 4011 to obtain Ŷₚⁱ.

Trⁱ is processed by using the common semantic extraction layer 4020 to obtain Teᵣⁱ. Teᵣⁱ is processed by using the semantic opinion extraction layer 4021 to obtain Yₛⁱ(\hat{T}oᵣⁱ). Teᵣⁱ is processed by using the domain prediction layer 4022 to obtain Y_{d}ⁱ(\hat{T}dᵣⁱ).

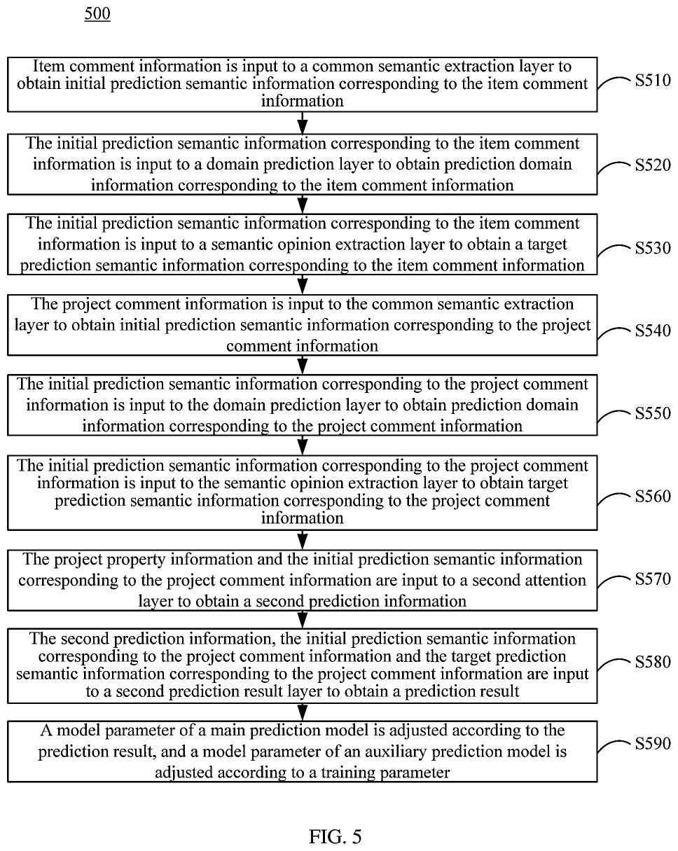

FIG. 5 schematically shows a flowchart of a method 500 of training a prediction model by using a training sample set according to another embodiment of the present disclosure.

As shown in FIG. 5, the method includes operations S510-S590.

In operation S510, an item comment information is input to a common semantic extraction layer to obtain an initial prediction semantic information corresponding to the item comment information.

In operation S520, the initial prediction semantic information corresponding to the item comment information is input to a domain prediction layer to obtain a prediction domain information corresponding to the item comment information.

In operation S530, the initial prediction semantic information corresponding to the item comment information is input to a semantic opinion extraction layer to obtain a target prediction semantic information corresponding to the item comment information.

In operation S540, the project comment information is input to the common semantic extraction layer to obtain an initial prediction semantic information corresponding to the project comment information.

In operation S550, the initial prediction semantic information corresponding to the project comment information is input to the domain prediction layer to obtain a prediction domain information corresponding to the project comment information.

In operation S560, the initial prediction semantic information corresponding to the project comment information is input to the semantic opinion extraction layer to obtain a target prediction semantic information corresponding to the project comment information.

In operation S570, the project property information and the initial prediction semantic information corresponding to the project comment information are input to a second attention layer to obtain a second prediction information.

In operation S580, the second prediction information, the initial prediction semantic information corresponding to the project comment information and the target prediction semantic information corresponding to the project comment information are input to a second prediction result layer to obtain a prediction result, and the prediction result is used to characterize a financial result of the project.

In operation S590, a model parameter of a main prediction model is adjusted according to the prediction result, and a model parameter of an auxiliary prediction model is adjusted according to a training parameter. The training parameter includes the prediction domain information and the target prediction semantic information corresponding to the item comment information.

According to the embodiment of the present disclosure, operations S570 and S580 are different from the method shown in FIG. 3. Another form of attention mechanism is used in the embodiment of the present disclosure, that is, the main prediction model may include the second attention layer and the second prediction result layer.

The second attention layer may be an attention layer processing the project property information and the target prediction semantic information corresponding to the project comment information. The second attention layer may be used to extract the common opinion information of the project property information and the item comment information. The reason why the second attention layer may be used to extract the common opinion information of the project property information and the item comment information is the semantic opinion extraction layer may be used to extract the target prediction semantic information corresponding to the project comment information and the target prediction semantic information corresponding to the item comment information. The purpose of the training is to enable the target prediction semantic information corresponding to the item comment information to characterize the target prediction semantic information corresponding to the project comment information. In other words, the target prediction semantic information corresponding to the project comment information have commonality with the target prediction semantic information corresponding to the item comment information, and the target prediction semantic information may be used to characterize the opinion information expressed by the comment information. Therefore, the second attention layer may be used to extract the common opinion information of the project property information and the item comment information.

According to the embodiment of the present disclosure, inputting the project property information, the initial prediction semantic information corresponding to the project comment information and the target prediction semantic information corresponding to the project comment information to the main prediction model to obtain the prediction result may include the operations S570-S580.

According to the embodiment of the present disclosure, the main prediction model may include the first attention layer and the first prediction result layer, the main prediction model may include the second attention layer and the second prediction result layer, and the main prediction model may further include the first attention layer, the first prediction result layer, the second attention layer and the second prediction result layer. The main prediction model may be set according to actual situations, which is not limited here.

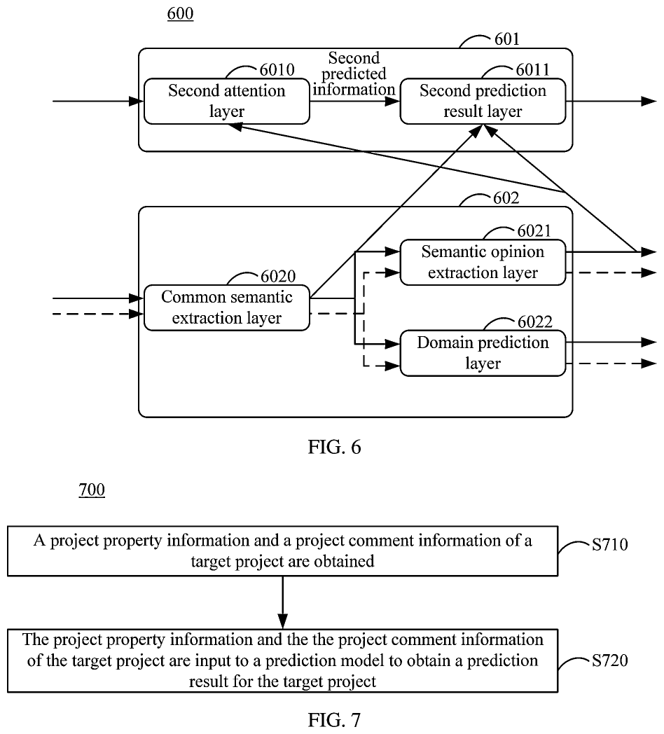

FIG. 6 schematically shows a schematic diagram of training a prediction model 600 by using a training sample set according to an embodiment of the present disclosure.

As shown in FIG. 6, a main prediction model 601 may include a second attention layer 6010 and a second prediction result layer 6011, an auxiliary prediction model 602 may include a common semantic extraction layer 6020, a semantic opinion extraction layer 6021 and a domain prediction layer 6022.

Project property information is characterized by fⁱ, project comment information is characterized by Tcⁱ, item comment information is characterized by Trⁱ. Initial prediction semantic information corresponding to the project comment information Tcⁱ is characterized by Te_{c}ⁱ, target prediction semantic information corresponding to the project comment information Tcⁱ is characterized by Yₛⁱ(\hat{T}o_{c}ⁱ), prediction domain information corresponding to the project comment information Tcⁱ is characterized by Y_{d}ⁱ(\hat{T}dᵣⁱ), and a prediction result corresponding to the project comment information Tcⁱ is characterized by Ŷₚⁱ.

Tcⁱ is processed by using the common semantic extraction layer 6020 to obtain Te_{c}ⁱ. Te_{c}ⁱ is processed by using the semantic opinion extraction layer 6021 to obtain Yₛⁱ(\hat{T}o_{c}ⁱ). Te_{c}ⁱ is processed by using the domain prediction layer 6022 to obtain Y_{d}ⁱ(\hat{T}dᵣⁱ). fⁱ and Yₛⁱ(\hat{T}o_{c}ⁱ) are processed by using the second attention layer 6010 to obtain second prediction information. The second prediction information, Te_{c}ⁱ and Yₛⁱ(\hat{T}o_{c}ⁱ) are processed by using the second prediction result layer 6011 to obtain Ŷₚⁱ.

Trⁱ is processed by using the common semantic extraction layer 6020 to obtain Teᵣⁱ. Teᵣⁱ is processed by using the semantic opinion extraction layer 6021 to obtain Yₛⁱ(\hat{T}oᵣⁱ). Teᵣⁱ is processed by using the domain prediction layer 6022 to obtain Y_{d}ⁱ(\hat{T}dᵣⁱ).

The above-mentioned embodiments are only exemplary embodiments, but are not limited thereto, and other methods known in the art may also be included, as long as the training prediction model may be realized.

FIG. 7 schematically shows a flowchart of a prediction method 700 according to an embodiment of the present disclosure.

As shown in FIG. 7, the method includes operations S710-S720.

In operation S710, a project property information and a project comment information of a target project are obtained.

In operation S720, the project property information and the project comment information of the target project are input to a prediction model to obtain a prediction result for the target project. The prediction model is trained according to the method for training a prediction model as described above.

According to the embodiment of the present disclosure, after obtaining the project property information and the item comment information of the target project, the above-mentioned information may be processed by using the prediction model obtained based on the method for training a prediction model provided by the embodiments of the present disclosure, so as to obtain the prediction result for the target project.

According to the embodiment of the present disclosure, the prediction result for the target project is obtained by inputting the project property information and the project comment information of the target project to the prediction model. The prediction model is obtained by training a training sample set. For example, by inputting the project comment information to an auxiliary prediction model to obtain initial prediction semantic information corresponding to the project comment information, training the main prediction model by using the project property information and the initial prediction semantic information corresponding to the project comment information, and training the auxiliary prediction model by using the item comment information, a joint training of the main prediction model and the auxiliary prediction model may be realized. In addition, since both the project comment information and the item comment information participate in the training of the auxiliary prediction model, it is possible to mine the market prospect information contained in the project comment information by using the item comment information, thereby improving a prediction accuracy of the prediction model. On this basis, an accuracy of the prediction result is improved.

According to the embodiment of the present disclosure, an apparatus of training a prediction model by using a training sample set is provided. The prediction model may include a main prediction model and an auxiliary prediction model, the training sample set may include a project information sample of a project and an item information sample of an item associated with the project, the project information sample may include a project property information and a project comment information, and the item information sample may include an item comment information.

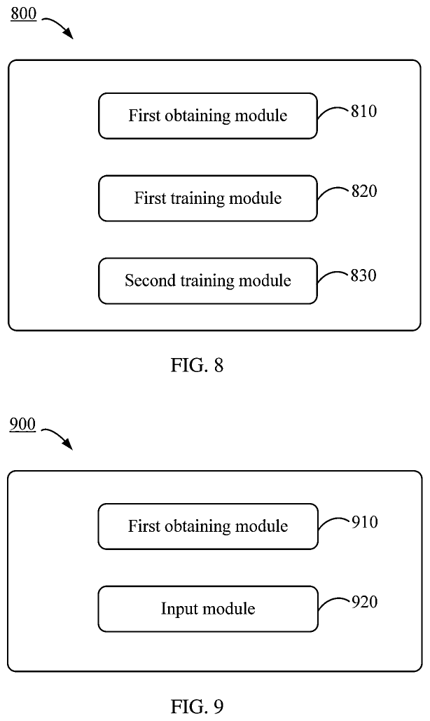

FIG. 8 schematically shows a block diagram of an apparatus of training a prediction model by using a training sample set according to an embodiment of the present disclosure.

As shown in FIG. 8, the apparatus 800 of training a prediction model by using a training sample set may include a first obtaining module 810, a first training module 820 and a second training module 830.

The first obtaining module 810 is used to input project comment information to the auxiliary prediction model to obtain an initial prediction semantic information corresponding to the project comment information.

The first training module 820 is used to train the main prediction model by using the project property information and the initial prediction semantic information corresponding to the project comment information.

The second training module 830 is used to train the auxiliary prediction model by using the item comment information.

According to the embodiment of the present disclosure, the auxiliary prediction model may include a common semantic extraction layer.

The first obtaining module 810 may include a first obtaining unit.

The first obtaining unit is used to input the project comment information to the common semantic extraction layer to obtain the initial prediction semantic information.

According to an embodiment of the present disclosure, the auxiliary prediction model may further include a semantic opinion extraction layer.

The first training module 820 may include a second obtaining unit, a third obtaining unit and a first adjusting unit.

The second obtaining unit is used to input the initial prediction semantic information to the semantic opinion extraction layer to obtain a target prediction semantic information corresponding to the project comment information.

The third obtaining unit is used to input the project property information, the initial prediction semantic information corresponding to the project comment information and the target prediction semantic information corresponding to the project comment information to the main prediction model to obtain a prediction result. The prediction result is used to characterize a financial result of the project.

The first adjustment unit is used to adjust a model parameter of the main prediction model according to the prediction result.

According to the embodiment of the present disclosure, the auxiliary prediction model may further include a domain prediction layer.

The second training module 830 may include a fourth obtaining unit, a fifth obtaining unit, a sixth obtaining unit, and a second adjusting unit.

The fourth obtaining unit is used to input the item comment information to the common semantic extraction layer to obtain an initial prediction semantic information corresponding to the item comment information.

The fifth obtaining unit is used to input the initial prediction semantic information corresponding to the item comment information to the domain prediction layer to obtain prediction domain information corresponding to the item comment information.

The sixth obtaining unit is used to input the initial prediction semantic information corresponding to the item comment information to the semantic opinion extraction layer to obtain target prediction semantic information corresponding to the item comment information.

The second adjustment unit is used to adjust a model parameter of the auxiliary prediction model according to the prediction domain information corresponding to the item comment information and the target prediction semantic information corresponding to the item comment information.

According to the embodiment of the present disclosure, the main prediction model may include a first attention layer and a first prediction result layer.

The third obtaining unit may include a first obtaining sub-unit and a second obtaining sub-unit.

The first obtaining sub-unit is used to input the project property information and the initial prediction semantic information corresponding to the project comment information to the first attention layer to obtain a first prediction information.

The second obtaining sub-unit is used to input the first prediction information, the initial prediction semantic information corresponding to the project comment information and the target prediction semantic information corresponding to the project comment information to the first prediction result layer to output the prediction result.

According to the embodiment of the present disclosure, the main prediction model includes a second attention layer and a second prediction result layer.

The third obtaining unit may include a third obtaining sub-unit and a fourth obtaining sub-unit.

The third obtaining sub-unit is used to input the project property information and the target prediction semantic information corresponding to the project comment information to the second attention layer in the main prediction model to obtain a second prediction information.

The fourth obtaining sub-unit is used to input the second prediction information, the initial prediction semantic information corresponding to the project comment information and the target prediction semantic information corresponding to the project comment information to the second prediction result layer to obtain the prediction result.

According to the embodiment of the present disclosure, the project information sample may further include a first real domain information and a real result, and the item comment information sample may further include a real semantic information and a second real domain information.

The above apparatus 800 of training a prediction model by using a training sample set may include a second obtaining module, a third obtaining module, a fourth obtaining module, a fifth obtaining module and an adjusting module.

The second obtaining module is used to obtain a first output value by using the target prediction semantic information corresponding to the item comment information and the real semantic information corresponding to the item comment information based on a first loss function.

The third obtaining module is used to obtain a second output value by using a prediction domain information corresponding to the project comment information and the first real domain information corresponding to the project comment information based on a second loss function. The prediction domain information corresponding to the project comment information is obtained by inputting the project comment information to the domain prediction layer.

The fourth obtaining module is used to obtain a third output value by using the prediction domain information corresponding to the item comment information and the second real domain information corresponding to the item comment information based on the second loss function.

The fifth obtaining module is used to obtain a fourth output value by using the prediction result corresponding to the project comment information and the real result corresponding to the project comment information based on a third loss function.

The adjusting module is used to adjust the model parameters of the main prediction model and the auxiliary prediction model according to the first output value, the second output value, the third output value and the fourth output value, until the first output value, the second output value, the third output value and the fourth output value are all converged.

According to the embodiment of the present disclosure, the adjusting module may include a first obtaining sub-module and an adjusting sub-module.

The first obtaining sub-module is used to process the first loss function, the second loss function and the third loss function by using a gradient descent algorithm to obtain a gradient vector. A component in the gradient vector related to the second loss function is characterized by a negative partial derivative.

The adjusting sub-module is used to adjust the model parameters of the main prediction model and the auxiliary prediction model according to the gradient vector.

According to the embodiment of the present disclosure, the above-mentioned apparatus 800 of training a prediction model by using a training sample set may further include a second obtaining module, a sixth obtaining module and a seventh obtaining module.

The second obtaining module is used to obtain an initial training sample set.

The sixth obtaining module is used to encode a project property information included in the initial training sample set to obtain the project property information included in the training sample set.

The seventh obtaining module is used to respectively process a project comment information and an item comment information included in the initial training sample set by using a convolutional neural network model, so as to obtain the project comment information and the item comment information included in the training sample set.

According to the embodiment of the present disclosure, the seventh obtaining module may include a second obtaining sub-module and a third obtaining sub-module.

The second obtaining sub-module is used to process the project comment information included in the initial training sample set by using a first convolutional neural network model to obtain the project comment information included in the training sample set.

The third obtaining sub-module is used to process the item comment information included in the initial training sample set by using a second convolutional neural network model to obtain the item comment information included in the training sample set.

FIG. 9 schematically shows a block diagram of a prediction apparatus according to an embodiment of the present disclosure.

As shown in FIG. 9, the prediction apparatus 900 may include a first obtaining module 910 and an input module 920.

The first obtaining module 910 is used to obtain a project property information and a project comment information of a target project.

The input module 920 is used to input the project property information and the project comment information of the target project to a prediction model to obtain a prediction result for the target project. The prediction model is trained by using the above-mentioned apparatus of training a prediction model.

Those skilled in the art should understand that by using the apparatus according to the embodiments of the present disclosure, the same technical effect as the method according to the embodiment of the present disclosure may be achieved, and the details will not be repeated here.

In the technical solution of the present disclosure, authorization or consent is obtained from the user before the user's personal information is obtained or collected.

According to the embodiments of the present disclosure, the present disclosure also provides an electronic device, a readable storage medium, and a computer program product.

According to the embodiment of the present disclosure, an electronic device may include: at least one processor; and a memory communicatively connected with the at least one processor; the memory is stored with instructions executable by the at least one processor, and the instructions, when executed by the at least one processor, cause the at least one processor to implement the method as described above.

According to the embodiment of the present disclosure, a non-transitory computer-readable storage medium stored with computer instructions is provided, the computer instructions cause a computer to implement the method as described above.

According to the embodiment of the present disclosure, a computer program product may include a computer program that, when executed by a processor, implements the method as described above.

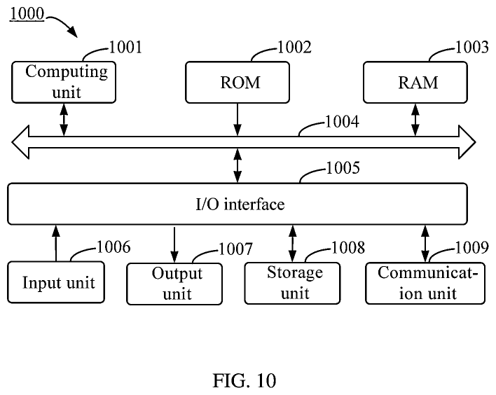

FIG. 10 shows a schematic block diagram of an electronic device 1000 suitable for implementing the embodiment of the present disclosure. The electronic device 1000 is intended to represent various forms of digital computers, such as a laptop computer, a desktop computer, a workstation, a personal digital assistant, a server, a blade server, a mainframe computer, and other suitable computers. The electronic device 1000 may also represent various forms of mobile apparatuses, such as a personal digital processor, a cellular phone, a smart phone, a wearable device, and other similar computing apparatuses. The components shown herein, connections and relationships thereof, and functions thereof are by way of example only, and are not intended to limit implementations of the disclosure described and/or claimed herein.

As shown in FIG. 10, the electronic device 1000 includes a computing unit 1001, the computing unit is capable of performing various suitable actions and processing based on a computer program stored in a read-only memory (ROM) 1002 or a computer program uploaded to a random-access memory (RAM) 1003 from a storage unit 1008. In the RAM 1003, various programs and data required for the operation of the electronic device 1000 may also be stored. The computing unit 1001, the ROM 1002, and the RAM 1003 are connected to each other through a bus 1004. An input/output (I/O) interface 1005 is also connected to the bus 1004.

A plurality of components in the electronic device 1000 are connected to the I/O interface 1005, including: an input unit 1006, such as a keyboard, a mouse, etc.; an output unit 1007, such as various types of displays, speakers, etc.; a storage unit 1008, such as a magnetic disk, an optical disk, etc.; and a communication unit 1009, such as a network card, a modem, a wireless communication transceiver, and the like. The communication unit 1009 enables the device 1000 to exchange information/data with other devices through a computer network such as the Internet and/or various telecommunication networks.

The computing unit 1001 may be various general-purpose and/or special-purpose processing components with processing and computing capabilities. Some examples of the computing unit 1001 include, but are not limited to, a central processing unit (CPU), a graphics processing unit (GPU), various specialized artificial intelligence (AI) computing chips, various computing units running machine learning model algorithms, a digital signal processing processor (DSP), and any suitable processor, controller, microcontroller, etc. The computing unit 1001 is used to execute the various methods and processing described above, such as the method of training a prediction model and/or the prediction method. For example, in some embodiments, the method of training a prediction model and/or the prediction method may be implemented as a computer software program tangibly embodied on a machine-readable medium, such as the storage unit 1008. In some embodiments, part or all of the computer program may be loaded and/or installed on the device 1000 via the ROM 1002 and/or the communication unit 1009. When the computer program is loaded to RAM 1003 and executed by the computing unit 1001, one or more steps of the above-described method of training a prediction model and/or the prediction method may be performed. Alternatively, in other embodiments, the computing unit 1001 may be configured by any other suitable means (e.g., by means of firmware) to perform the method of training a prediction model and/or the prediction method.

Various implementations of the system and technique described above may be implemented in a digital electronic circuit, an integrated circuit system, a field programmable gate array (FPGA), an application specific integrated circuit (ASIC), an application specific standard product (ASSP), a system-on-a-chip (SOC), a complex programmable logic device (CPLD), computer hardware, firmware, software, and/or a combination thereof. These various implementations may include: being implemented in one or more computer programs executable and/or interpretable on a programmable system including at least one programmable processor. The programmable processor may be a special-purpose or general-purpose programmable processor, the programmable processor may receive data and instructions from a storage system, at least one input apparatus, and at least one output apparatus, and transmit data and instructions to the storage system, the at least one input apparatus, and the at least one output apparatus.

Program codes for implementing the method of the present disclosure may be written in any combination of one or more programming languages. The program codes may be provided to a processor or controller of a general-purpose computer, a special-purpose computer or other programmable data processing apparatuses, such that when executed by the processor or controller, the program codes enables functions/operations specified in the flowchart and/or block diagram to be implemented. The program codes may be executed entirely on the machine, partly on the machine, partly on the machine and partly on a remote machine as a stand-alone software package or entirely on the remote machine or server.

In the context of the present disclosure, a machine-readable medium may be a tangible medium that may include or store a program for use by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an one or more wire-based electrical connection, a portable computer disk, a hard disk, a random access memory (RAM), a read only memory (ROM), an erasable programmable read only memory (EPROM or flash memory), an optical fiber, a compact disk read only memory (CD-ROM), an optical storage device, a magnetic storage device, or any suitable combination thereof.

To provide an interaction with a user, the system and technique described herein may be implemented on a computer having: a display apparatus (e.g., a CRT (cathode ray tube) or an LCD (liquid crystal display) monitor) for displaying information to the user; and a keyboard and pointing apparatus (e.g., a mouse or trackball) through which the user may provide input to the computer. Other types of apparatuses may also be used to provide the interaction with the user. For example, a feedback provided to the user may be any form of sensory feedback (e.g., visual feedback, auditory feedback, or tactile feedback); and may receive input in any form (including acoustic input, voice input, or tactile input) from the user.

The system and technique described herein may be implemented on a computing system including back-end components (e.g., as a data server), or a computing system including middleware components (e.g., an application server), or a computing system including front-end components (e.g., a user's computer with a graphical user interface or a web browser through which the user may interact with implementations of the system and technique described herein), or a computing system including any combination of such back-end components, middleware components, or front-end components. The components of the system may be interconnected by any form or medium of digital data communication (e.g., a communication network). Examples of the communication network includes: a Local Area Network (LAN), a Wide Area Network (WAN), and the Internet.

A computer system may include a client and a server. The client and the server are generally remote from each other and usually interact through a communication network. A relationship between the client and the server is generated by computer programs running on respective computers and having a client-server relationship to each other. The server may be a cloud server, or a server of a distributed system, or a server combined with a blockchain.

It should be understood that steps may be reordered, added or deleted using the various forms of the flow shown above. For example, the steps described in the present disclosure may be executed in parallel, sequentially, or in different orders, as long as the desired result of the technical solution disclosed in the present disclosure may be achieved, which is not limited herein.

The above-mentioned specific embodiments do not constitute a limitation to the protection scope of the present disclosure. It should be understood by those skilled in the art that various modifications, combinations, sub-combinations and substitutions may occur depending on design requirements and other factors. Any modifications, equivalent replacements, and improvements made within the spirit and principles of the present disclosure should be included within the protection scope of the present disclosure.

What is claimed is:

1. A method of training a prediction model by using a training sample set, wherein the prediction model comprises a main prediction model and an auxiliary prediction model, the training sample set comprises a project information sample of a project and an item information sample of an item associated with the project, the project information sample comprises a project property information and a project comment information, and the item information sample comprises an item comment information, and the method comprises:
inputting the project comment information to the auxiliary prediction model to obtain an initial prediction semantic information corresponding to the project comment information;
training the main prediction model by using the project property information and the initial prediction semantic information corresponding to the project comment information; and
training the auxiliary prediction model by using the item comment information.

2. The method according to claim 1, wherein the auxiliary prediction model comprises a common semantic extraction layer;
wherein the inputting the project comment information to the auxiliary prediction model to obtain an initial prediction semantic information corresponding to the project comment information comprises:
inputting the project comment information to the common semantic extraction layer to obtain the initial prediction semantic information corresponding to the project comment information.

3. The method according to claim 2, wherein the auxiliary prediction model further comprises a semantic opinion extraction layer;
wherein the training the main prediction model by using the project property information and the initial prediction semantic information corresponding to the project comment information comprises:
inputting the initial prediction semantic information corresponding to the project comment information to the semantic opinion extraction layer to obtain a target prediction semantic information corresponding to the project comment information;
inputting the project property information, the initial prediction semantic information corresponding to the project comment information, and the target prediction semantic information corresponding to the project comment information to the main prediction model to obtain a prediction result, wherein the prediction result is configured to characterize a financial result of the project; and
adjusting a model parameter of the main prediction model based on the prediction result.

4. The method according to claim 2, wherein the auxiliary prediction model further comprises a domain prediction layer;
wherein the training the auxiliary prediction model by using the item comment information comprises:
inputting the item comment information to the common semantic extraction layer to obtain an initial prediction semantic information corresponding to the item comment information;
inputting the initial prediction semantic information corresponding to the item comment information to the domain prediction layer to obtain a prediction domain information corresponding to the item comment information;
inputting the initial prediction semantic information corresponding to the item comment information to the semantic opinion extraction layer to obtain a target prediction semantic information corresponding to the item comment information; and
adjusting a model parameter of the auxiliary prediction model based on the prediction domain information corresponding to the item comment information and the target prediction semantic information corresponding to the item comment information.

5. The method according to claim 3, wherein the main prediction model comprises a first attention layer and a first prediction result layer;
wherein the inputting the project property information, the initial prediction semantic information corresponding to the project comment information, and the target prediction semantic information corresponding to the project comment information to the main prediction model to obtain a prediction result comprises:
inputting the project property information and the initial prediction semantic information corresponding to the project comment information to the first attention layer to obtain a first prediction information; and
inputting the first prediction information, the initial prediction semantic information corresponding to the project comment information and the target prediction semantic information corresponding to the project comment information to the first prediction result layer to obtain the prediction result.

6. The method according to claim 3, wherein the main prediction model comprises a second attention layer and a second prediction result layer;
wherein the inputting the project property information, the initial prediction semantic information corresponding to the project comment information, and the target prediction semantic information corresponding to the project comment information to the main prediction model to obtain a prediction result comprises:
inputting the project property information, and the target prediction semantic information corresponding to the project comment information to the second attention layer in the main prediction model to obtain a second prediction information; and
inputting the second prediction information, the initial prediction semantic information corresponding to the project comment information and the target prediction semantic information corresponding to the project comment information to the second prediction result layer to obtain the prediction result.

7. The method according to claim 4, wherein the project information sample further comprises a first real domain information and a real result, and the item comment information sample further comprises a real semantic information and a second real domain information;
the method further comprises:
obtaining a first output value based on a first loss function by using the target prediction semantic information corresponding to the item comment information and the real semantic information corresponding to the item comment information;
obtaining a second output value based on a second loss function by using a prediction domain information corresponding to the project comment information and the first real domain information corresponding to the project comment information, wherein the prediction domain information corresponding to the project comment information is obtained by inputting the project comment information to the domain prediction layer;
obtaining a third output value based on the second loss function by using the prediction domain information corresponding to the item comment information and the second real domain information corresponding to the item comment information;
obtaining a fourth output value based on a third loss function by using the prediction result corresponding to the project comment information and the real result corresponding to the project comment information; and
adjusting the model parameters of the main prediction model and the auxiliary prediction model based on the first output value, the second output value, the third output value and the fourth output value until the first output value, the second output value, the third output value and the fourth output value are all converged.

8. The method according to claim 7, wherein the adjusting the model parameters of the main prediction model and the auxiliary prediction model comprises:
processing the first loss function, the second loss function and the third loss function by using a gradient descent algorithm to obtain a gradient vector, wherein a component in the gradient vector associated with the second loss function is characterized by a negative partial derivative; and
adjusting the model parameters of the main prediction model and the auxiliary prediction model based on the gradient vector.

9. The method according to claim 1, further comprises:
obtaining an initial training sample set;
encoding a project property information comprised in the initial training sample set to obtain the project property information comprised in the training sample set; and
processing a project comment information and an item comment information comprised in the initial training sample set respectively by using a convolutional neural network model, to obtain the project comment information and the item comment information comprised in the training sample set.

10. The method according to claim 9, wherein the processing a project comment information and an item comment information comprised in the initial training sample set respectively by using a convolutional neutral network model, to obtain the project comment information and the item comment information comprised in the training sample set comprises:
processing the project comment information comprised in the initial training sample set by using a first convolutional neural network model, to obtain the project comment information comprised in the training sample set; and
processing the item comment information comprised in the initial training sample set by using a second convolutional neural network model, to obtain the item comment information comprised in the training sample set.

11. A prediction method, comprising:
obtaining a project property information and a project comment information of a target project; and
inputting the project property information and the project comment information of the target project to a prediction model to obtain a prediction result for the target project,
wherein the prediction model is trained by using the method according to claim 1.

12. An electronic device, comprising:
at least one processor; and
a memory communicatively connected with the at least one processor;
wherein the memory stores instructions executable by the at least one processor, and the instructions, when executed by the at least one processor, cause the at least one processor to implement the method according to claim 1.

13. The electronic device according to claim 12, wherein the auxiliary prediction model comprises a common semantic extraction layer;
wherein the instructions further cause the at least one processor to:
input the project comment information to the common semantic extraction layer to obtain the initial prediction semantic information corresponding to the project comment information.

14. The electronic device according to claim 13, wherein the auxiliary prediction model further comprises a semantic opinion extraction layer;
wherein the instructions further cause the at least one processor to:
input the initial prediction semantic information corresponding to the project comment information to the semantic opinion extraction layer to obtain a target prediction semantic information corresponding to the project comment information;
input the project property information, the initial prediction semantic information corresponding to the project comment information, and the target prediction semantic information corresponding to the project comment information to the main prediction model to obtain a prediction result, wherein the prediction result is configured to characterize a financial result of the project; and
adjust a model parameter of the main prediction model based on the prediction result.

15. The electronic device according to claim 13, wherein the auxiliary prediction model further comprises a domain prediction layer;
wherein the instructions further cause the at least one processor to:
input the item comment information to the common semantic extraction layer to obtain an initial prediction semantic information corresponding to the item comment information;
input the initial prediction semantic information corresponding to the item comment information to the domain prediction layer to obtain a prediction domain information corresponding to the item comment information;
input the initial prediction semantic information corresponding to the item comment information to the semantic opinion extraction layer to obtain a target prediction semantic information corresponding to the item comment information; and
adjust a model parameter of the auxiliary prediction model based on the prediction domain information corresponding to the item comment information and the target prediction semantic information corresponding to the item comment information.

16. The electronic device according to claim 14, wherein the main prediction model comprises a first attention layer and a first prediction result layer;
wherein the instructions further cause the at least one processor to:
input the project property information and the initial prediction semantic information corresponding to the project comment information to the first attention layer to obtain a first prediction information; and
input the first prediction information, the initial prediction semantic information corresponding to the project comment information and the target prediction semantic information corresponding to the project comment information to the first prediction result layer to obtain the prediction result.

17. The electronic device according to claim 14, wherein the main prediction model comprises a second attention layer and a second prediction result layer;
wherein the instructions further cause the at least one processor to:
input the project property information, and the target prediction semantic information corresponding to the project comment information to the second attention layer in the main prediction model to obtain a second prediction information; and
input the second prediction information, the initial prediction semantic information corresponding to the project comment information and the target prediction semantic information corresponding to the project comment information to the second prediction result layer to obtain the prediction result.

18. An electronic device, comprising:
at least one processor; and
a memory communicatively connected with the at least one processor;
wherein the memory stores instructions executable by the at least one processor, and the instructions, when executed by the at least one processor, cause the at least one processor to implement the method according to claim 11.

19. A non-transitory computer-readable storage medium having computer instructions stored thereon, wherein the computer instructions are configured to cause a computer to implement the method according to claim 1.

20. A non-transitory computer-readable storage medium having computer instructions stored thereon, wherein the computer instructions are configured to cause a computer to implement the method according to claim 11.
